(19) United States
(12) Patent Application Publication
(10) Pub. No.: US 2017/0138750 A1
(43) Pub. Date: May 18, 2017

(54) Charging at Charging Stations for Range Extension

(71) Applicant: Bayerische Motoren Werke Aktiengesellschaft, Muenchen (DE)

(72) Inventor: Robert WEBER, Schliersee (DE)

(21) Appl. No.: 15/417,261

(22) Filed: Jan. 27, 2017

Related U.S. Application Data
(63) Continuation of application No. PCT/EP2015/066016, filed on Jul. 14, 2015.

(30) Foreign Application Priority Data
Jul. 29, 2014 (DE) 10 2014 214 806.5

(51) Int. Cl. G01C 21/34; G06Q 10/02; B60L 11/18

(52) U.S. Cl. CPC G01C 21/3469; B60L 11/1824; G06Q 10/02

(57) ABSTRACT

A method and a corresponding device are provided for extending the range of vehicles having an electric drive. A control unit for a vehicle that is driven by an electric motor, which is operated by electrical energy from an electrical energy store, is described. The control unit is designed to determine a first state of charge of the energy store at a starting position of the vehicle and to determine a first range of the vehicle starting from the starting position on the basis of the first state of charge. Furthermore, the control unit is designed to determine that the first range of the vehicle is insufficient for reaching a target position of the vehicle. The control unit is also designed to determine a changing region between the starting position and the target position on the basis of a second state of charge of the energy store and on the basis of the first range. The second state of charge corresponds to an assumed state of charge of the energy store after a charging process is carried out at a charging location on a route between the starting position and the target position. In addition, the control unit is designed to determine one or more possible charging locations in the charging region on the basis of digital map information.

### CROSS REFERENCE TO RELATED APPLICATIONS

This application is a continuation of PCT International Application No. PCT/EP2015/066016, filed Jul. 14, 2015, which claims priority under 35 U.S.C. §119 from German Patent Application No. 10 2014 214 806.5, filed Jul. 29, 2014, the entire disclosures of which are herein expressly incorporated by reference.

### BACKGROUND AND SUMMARY OF THE INVENTION

The invention relates to method and a corresponding apparatus for extending the range of vehicles with an electric drive.

The range of battery-powered electric vehicles (BEVs) can be insufficient for certain destinations of the BEVs, because more electrical energy is required to reach the destination than is stored in the battery. The battery of the vehicle must therefore be charged during the journey to the destination.

The present document is concerned with the technical object of assisting the driver of a battery-powered vehicle in an optimal manner during the selection of a route to a destination, wherein the destination lies outside a range that can be reached with the current battery charge level.

This and other objects are achieved according to one aspect of the invention, by a control unit for a vehicle (for example for a road vehicle such as a passenger vehicle, a truck or a motorcycle). The vehicle is driven by an electric motor that is operated by electrical energy from an electrical energy store. The energy store can be a battery, for example a high-voltage battery.

The control unit is arranged to determine a first charge state (for example a state of charge, SOC) of the energy store at a starting position of the vehicle. The starting position of the vehicle can for example be determined by position data (for example by GPS coordinates) of the vehicle. The control unit is further arranged to determine a first range of the vehicle starting from the starting position based on the first state of charge. During this, a typical energy consumption of the vehicle can be assumed. Furthermore, the driving behavior of the driver of the vehicle can be taken into account. Moreover, the consumption of one or more further active electrical loads of the vehicle can be taken into account.

The control unit is further arranged to determine that the first range of the vehicle is not sufficient to drive to a destination position of the vehicle. The destination position of the vehicle can for example have been detected by way of an input by a driver of the vehicle (for example as a desired destination). The control unit can be arranged to determine a route to the destination position. Furthermore, the control unit can be arranged to detect that the route is longer than the first range. The control unit can thereby detect a range deficiency of the vehicle in relation to the desired destination position.

Furthermore, the control unit is arranged to determine a charging region between the starting position and the destination position based on a second state of charge of the energy store and based on the first range. In doing so, the second state of charge can correspond to an assumed state of charge of the energy store after carrying out a charging process at a charging point on a route between the starting position and the destination position. The second state of charge can for example be predefined. In particular, the second state of charge can be determined depending on a charge profile of the energy store. Typically, electrochemical batteries can be charged at a relatively high rate of charge up to a SOC of approx. 80%. The rate of charge typically reduces with increasing SOC (in particular for SOCs of 80% or more). The second state of charge can thereby be selected depending on the rate of charge of the energy store. For example, a SOC of approx. 80% can be selected as a second state of charge.

The control unit can be arranged to determine a second range of the vehicle starting from the destination position based on the second state of charge. The second range can also be considered to be the maximum possible distance of the charging point from the destination position. Furthermore, the control unit can be arranged to determine the charging region between the starting position and the destination position based on the first range and based on the second range. In particular, the charging region can be determined as the overlap region of a first region about the starting position and of a second region about the destination position, wherein the first region depends on the first range and wherein the second region depends on the second range.

The control unit is further arranged to determine one or more possible charging points within the charging region based on digital map information. For this purpose, charging stations and the corresponding positions (i.e. charging locations) can be noted in the digital map information (for example as points of interest, POIs). By the selection of possible charging locations/charging stations within the determined charging region, the range of the vehicle can be increased in a reliable manner. Furthermore, further aspects (in particular a driving time between the starting position and the end position) can be taken into account and optimized.

The control unit can be arranged to cause an output unit (for example a display screen) of the vehicle, to output information about the one or more possible charging locations to a user of the vehicle. In particular, information about one or more charging stations that are available at the corresponding one or more charging locations can be determined. The information about a charging station can for example include one or more of: the available charging performance of the charging station; the availability of DC charging (i.e. of rapid charging); an operating state of the charging station; the availability of a free charging place at the charging station at a predicted time in the future at the charging station; a predicted charging time to bring the energy in the energy store to the second state of charge; and/or services available at the charging station (such as for example a restaurant or WLAN).

The control unit can be arranged to cause the output unit of the vehicle to output the information about the one or more charging stations. The output of such information enables the user of the vehicle to select a charging station (i.e. a charging location) that is optimum for him. In particular, a charging station (and hence a charging location) can be selected at which the charging process can be carried out in a very short charging time (i.e. in a very short period of time).

The control unit can be further arranged to determine, based on an input detected by way of an input unit (for example a keyboard or a touchscreen) of the vehicle, the selected charging location from the one or more possible charging locations (i.e. to determine the charging location that has been selected by the user of the vehicle). Furthermore, the control unit can be arranged to determine a route to the destination position via the selected charging location (as a waypoint), based on the digital map information. The user can thus be assisted in an effective manner during his journey to the destination position and the extension of the range associated therewith.

The control unit can be arranged to predict an arrival time at the selected charging location. Furthermore, the control unit can be arranged to send a reservation request with the predicted arrival time to the charging station at the selected charging location by way of a communications unit of the vehicle (for example by means of a wireless communications network such as UMTS, GPRS or LTE). Thus, waiting times for the user at the selected charging station can be reduced.

The control unit can be arranged to determine a charging performance of the available charging station at the corresponding possible charging location for each of the one or more possible charging locations (in particular when there are multiple charging locations). Furthermore, a predicted state of charge of the energy store on arrival at the corresponding possible charging location can be determined. Thus, a charging time for a charging process to bring the energy store to a third state of charge can be determined based on the determined charging performance and based on the predicted state of charge. The charging times of the possible charging stations can be notified to a user by way of the output unit of the vehicle. By taking in to account the predicted state of charge on arrival at a possible charging location, the charging time can be precisely determined.

The third state of charge for calculating the charging time can correspond to the second state of charge that has been used to determine the charging region in this case. Alternatively, the third state of charge can correspond to a charging location-dependent state of charge. The control unit can in particular be arranged to determine the charging location-dependent state of charge of a possible charging location depending on a route between the possible charging location and the destination position. For example, the third state of charge of a possible charging location can correspond to the state of charge that must at least be present so that the vehicle can reliably reach the destination position from the possible charging location. By determining such a third state of charge, the journey time to the destination position can be further reduced. In doing so, the journey time typically includes the pure driving time of the vehicle and the necessary charging time.

The control unit can be arranged to determine a driving time for a route via the corresponding possible charging location to the destination position for each of the one or more possible charging locations. Furthermore, the control unit can be arranged to determine a preferred charging location based on the sum of corresponding determined charging times and determined driving times. In particular, the charging location can be determined from the one or more possible charging locations that enables a minimum journey time (i.e. a minimum sum of the driving time and charging time). The control unit can thereby assist the user of the vehicle during this to extend the range of the vehicle with minimum time expenditure.

According to a further aspect, a vehicle (for example a passenger vehicle, a truck or a motorcycle) is described that includes a control unit that is described in this document.

According to a further aspect, a method for determining possible charging locations for the charging of an electrical energy store of a vehicle with an electric drive is described. The method comprises determining a first state of charge of the energy store at a starting position of the vehicle and determining a first range of the vehicle starting from the starting position based on the first state of charge. Furthermore, the method comprises determining that the first range of the vehicle is insufficient to reach a destination position of the vehicle, as well as determining a charging region between the starting position and the destination position based on a second state of charge of the energy store and based on the first range. During this, the second state of charge corresponds to an assumed state of charge of the energy store after carrying out a charging process at a charging location on a route between the starting position and the destination position. Moreover, the method comprises determining one or more possible charging locations in the charging region based on digital map information.

According to a further aspect, a software (SW) program is described. The SW program can be arranged to be executed on a processor (for example on a control unit of a vehicle), and as a result to carry out the method described in this document.

According to a further aspect, a memory medium is described. The memory medium can have stored thereon a SW program that is arranged to be executed on a processor and as a result to carry out the method described in this document.

It should be noted that the methods, apparatuses and systems described in this document can be used both on their own and also in combination with other methods, apparatuses and systems described in this document. Furthermore, any aspects of the methods, apparatus and systems described in this document can be combined with each other in a variety of ways.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a diagrammatic example of a route planning situation.

FIG. 2 is a highly schematic block diagram of examples of components of a vehicle.

FIG. 3 is a flow chart of an example of a method for determining charging stations.

### DETAILED DESCRIPTION OF THE DRAWINGS

As initially stated, the present document is concerned with the technical object of extending the range of a vehicle with an electric drive in an optimal manner. Furthermore, the present document is concerned with the technical object of assisting the driver of such a vehicle during the determination of a route extending beyond the range of the vehicle from a starting point to a destination point.

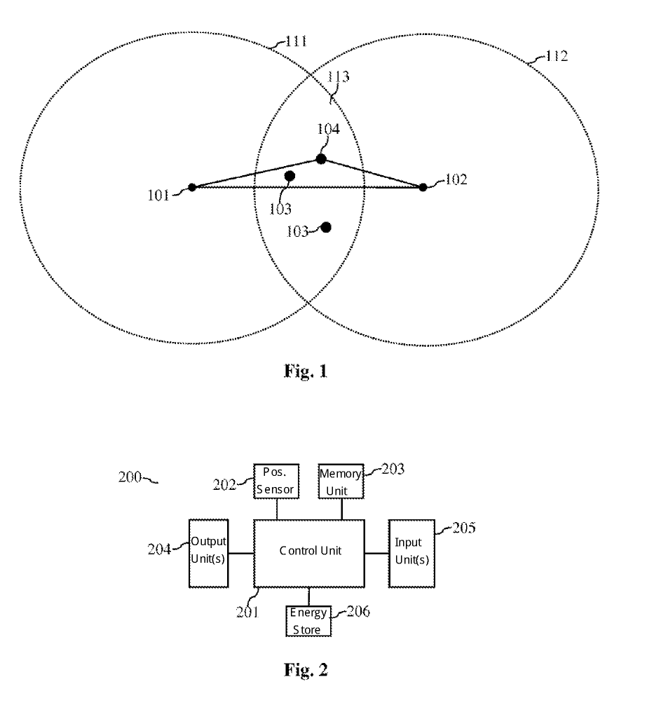

FIG. 1 shows an example of a route from a starting point 101 (also referred to as a starting position) to a destination point 102 (also referred to as a destination position). The direct connecting line between the starting point 101 and the destination point 102 represents a direct route that corresponds to defined optimization criteria (such as for example a fastest route or a shortest route). However, the vehicle, which is intended to travel from the starting point 101 to the destination point 102, has a limited range owing to the limited capacity of an electrical energy store (for example a battery) of the vehicle. The range can be shorter than the length of the “direct” route between the starting point 101 and the destination point 102. In this case, it is necessary that the energy store of the vehicle is charged en route between the starting point 101 and the destination point 102.

FIG. 2 shows a block diagram of examples of components of a vehicle 200. The vehicle 200 includes a control unit 201 that is arranged to determine a route between the starting point 101 and the destination point 102. For this purpose, the control unit 201 can be arranged to receive position data of the vehicle 200 from a position sensor 202 (for example from a GPS receiver or a Galileo receiver). Furthermore, the control unit 201 can access digital map information that can be stored in a memory unit 203 of the vehicle 200. The digital map information can include information about
a road network between the starting point 101 and the destination point 102;
   and/or
possible charging stations and corresponding charging locations 103, 104 along the road network between the starting point 101 and the destination point 102;
   and/or
characteristics of the charging stations, such as for example a type of the charging station (AC charging or DC data) and/or a possible charging performance.

Furthermore, the vehicle 200 includes an input unit 205, which for example comprises a keyboard. The input unit 205 is arranged to detect an input of a user of the vehicle 200, for example an input regarding the destination point 102. The control unit 201 is arranged to determine a route for the vehicle 200 based on the position data, based on the digital map information and/or based on the detected input regarding the destination point 102. Furthermore, the control unit 201 can be arranged to cause an output unit 204 of the vehicle 200 to output the determined route (for example on a display screen of the output unit 204).

The control unit 201 can further be arranged to determine information about a current charge state (for example regarding a state of charge, SOC) of the energy store 206 of the vehicle 200. The current state of charge is also referred to in this document as the first state of charge. Furthermore, the control unit 201 can be arranged to determine a possible range 111 of the vehicle 200 starting from the current position 101 of the vehicle 200 (i.e. starting from the starting point 101) based on the first state of charge.

Furthermore, the control unit 201 can be arranged to determine a maximum possible distance 112 from the destination point 102, assuming a determined state of charge after carrying out a charging process at a charging station on a route between the starting point 101 and the destination point 102. The assumed state of charge after carrying out a charging process is also referred to in this document as the second state of charge. The maximum possible distance 112 from the destination point 102 is also referred to in this document as the second range.

As shown in FIG. 1, the range 111 of the vehicle 200 from the starting point 101 and the possible distance 112 of the vehicle 200 from the destination point 102 provide a region 113, in which the vehicle 200 should be charged in order to travel from the starting point 101 to the destination point 102 with a charging process. The region 113 is referred to in this document as the charging region. The charging region 113 is the overlap of the regions spanned by the range 111 and by the possible distance 112.

Possible charging points 103, 104 (also referred to as charging locations) in the region 113 with charging stations for charging the energy store 206 of the vehicle 200 can be identified using the digital map information. The control unit 201 can thereby be arranged to determine one or more charging points 103, 104 with charging stations for the vehicle 200 based on the range 111 of the vehicle 200 from the starting point 101 and based on the possible distance 112 of the vehicle 200 from the destination point 102.

The control unit 201 can further be arranged to output information about the one or more charging points 103, 104 and the charging stations available there by means of the output unit 204. In particular, one or more of the following items of information can be output:
operating state of the charging station (operational/non-operational);
charging station occupied/reserved (in particular at the predicted point in time of arrival at the charging station);
available charging performance of the charging station;
required charging time to bring the energy storage means to the second state of charge and/or to a state of charge that is sufficient to reach the destination point 102 from the charging station;
   and/or
services provided by the charging station (restaurant, WLAN usage, etc.).

The user then has the option of selecting one of the indicated charging locations 113, 114 or charging stations. The control unit 201 can be arranged to detect the input of the user and thereupon to determine a route for the vehicle via the selected charging location 104 as a waypoint.

In particular, the user can select a charging station that enables a short charging time, and thereby reduces (possibly minimizes) the journey time from the starting point 101 to the destination 112, in an effective manner. In particular, a charging station can be selected that enables DC charging of the energy storage means 206 of the vehicle 200, and thus typically a reduced charging time.

In other words, if a user has entered the destination 102 by use of an input unit 205 (for example by use of a navigation device), it can be determined whether there is a range deficiency, i.e. whether at least one charging process is necessary in order to reach the destination 102, based on the difference between the possible range 111 and the distance to the destination 102. In order to bridge the range deficiency, as described above, a charging region 113 can be determined in which the energy store 206 of the vehicle 200 can be charged. The size of the charging region 113 depends on the first state of charge (at the starting point 101) and on the second state of charge (after carrying out the charging process). The control unit 201 can be arranged to determine the possible charging locations 103, 104 in the charging region 113.

From the available charging performance of the charging stations (in particular the DC charging stations) at the possible charging locations 103, 104, possibly by incorporating the information about the availability of the station (operational/non-operational, reserved, occupied at the point in time of arrival at the charging location 103, 104, etc.), the charging locations 103, 104 having positive availability can be indicated to the driver of the vehicle 200 by the output unit 204 (for example by the navigation device). In addition, the necessary charging time (calculated from the available performance of the charging station) that is necessary to charge the amount of energy that is required to bridge the range deficiency can be indicated. The driver can now decide, using the charging times and the possible charging locations 103, 104, which charging station should be visited. After confirmation of a charging location 104, the confirmed charging location 104 can be taken into account as a waypoint during the determination of a route.

After determining the desired charging location 104, the estimated point in time of arrival at the charging location 104 can be determined by the control unit 201 (for example by the navigation device). The control unit 201 can further be arranged to a send a reservation request to an operator of the selected charging station by way of a communications unit (not shown) of the vehicle 200. Furthermore, a reservation confirmation can be received by way of the communications unit and may be indicated by the output unit 204.

In order to enable a better choice of charging locations 104 for the driver, additional services of the charging stations (for example the provision of a restaurant, WLAN usage, shops, etc.) may be determined and indicated, which the driver of the vehicle 200 can use to pass the charging time.

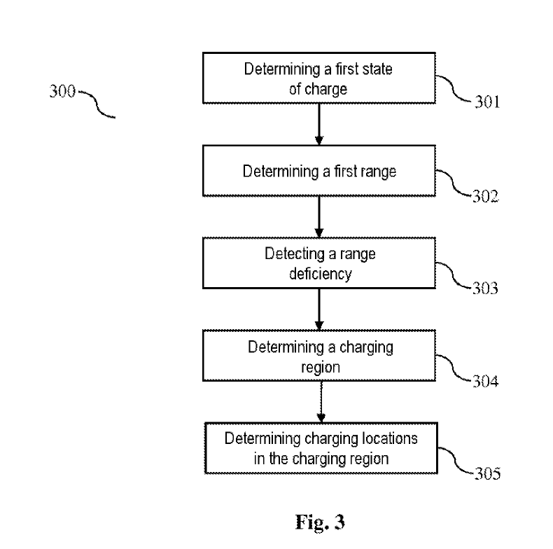

FIG. 3 shows a flow chart of an example of a method 300 for determining possible charging locations 103, 104 for the charging of the electrical energy store 206 of a vehicle 200 with an electric drive. The method 300 includes determining 301 a first state of charge of the energy store 206 at a starting position 101 (also referred to as a starting point) of the vehicle 200. The starting position 101 can for example be determined based on position data of the vehicle 200. The first state of charge can for example be determined as the current SOC of the energy store.

The method 300 further includes determining 302 a first range 111 of the vehicle 200 starting from the starting position 101 based on the first state of charge. Moreover, the method 300 includes determining 303 that the first range 111 of the vehicle 200 is insufficient to reach a destination position 102 of the vehicle 200. In other words, a range deficiency relative to the destination position 102 (also referred to as the destination point) can be identified.

Furthermore, the method 300 includes determining 304 a charging region 113 between the starting position 101 and the destination position 102 based on a second state of charge of the energy store 206 and based on the first range 111. In doing so, the second state of charge can correspond to an assumed state of charge of the energy store 206 after carrying out a charging process at a charging location 104 on a route between the starting position 101 and the destination position 102. The second state of charge can be a SOC of the energy store 206 that will be achieved by the charging process at the charging location 204 (for example a SOC of 80%).

Moreover, the method 300 includes determining 305 one or more possible charging locations 103, 104 in the charging region 113 based on digital map information. It is thereby guaranteed by the method 300 that the range of the vehicle 200 can be extended in a reliable manner. In doing so, further information about the charging stations at the one or more possible charging locations 103, 104 (in particular the charging times) can be determined in order to enable a very fast journey (i.e. a short journey time) between the starting position 101 and the destination position 102. For this purpose, a charging location 104 that enables a minimum journey time can be selected from the one or more possible charging locations 103, 104.

The method described in this document enables the user of a battery-powered electric vehicle to increase the range of the vehicle in a very effective and time-saving manner. In particular, the charging times of the vehicle and thereby the journey times to a destination position can be reduced by the method described.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A control unit for a vehicle that is driven by an electric motor with electrical energy from an electrical energy store, comprising:
a processor configured to execute processing to:
determine a first state of charge of the energy store at a starting position of the vehicle;
determine a first range of the vehicle starting from the starting position based on the first state of charge;
determine that the first range of the vehicle is insufficient to travel to a destination position of the vehicle;
based on a second state of charge of the energy store and based on the first range, determine a charging region between the starting position and the destination position, wherein the second state of charge corresponds to an assumed state of charge of the energy store after carrying out a charging process at a charging location on a route between the starting position and the destination position; and
determine one or more possible charging locations in the charging region based on digital map information.

2. The control unit as claimed in claim 1, wherein the processor further executes processing to:
determine a second range of the vehicle starting from the destination position based on the second state of charge; and
determine the charging region between the starting position and the destination position based on the first range and based on the second range.

3. The control unit as claimed in claim 2, wherein the processor further executes processing to:
cause an output unit of the vehicle to output information about the one or more possible charging locations to a user of the vehicle;
determine a selected charging location from the one or more possible charging locations based on an input detected by way of an input unit of the vehicle; and
determine a route to the destination position via the selected charging location based on the digital map information.

4. A control unit as claimed in claim 3, wherein the processor further executes processing to:
determine information about one or more charging stations that are available at the one or more charging locations; and
cause the output unit of the vehicle to output the information about the one or more charging stations.

5. The control unit as claimed in claim 4, wherein the information about a charging station comprises one or more of:
an available charging performance of the charging station;
an availability of DC charging;
an operating state the charging station;
an availability of a free charging place at the charging station at a predicted time in the future at the charging station;
a predicted charging time to bring the energy store to the second state of charge; and
services available at the charging station.

6. The control unit according to claim 1, wherein the processor further executes processing to:
predict an arrival time at the selected charging location; and
send a reservation request with the predicted arrival time at a charging station to the selected charging location by way of a communications unit of the vehicle.

7. The control unit as claimed in claim 1, wherein the processor further executes processing, for each of the one or more possible charging locations, to:
determine the charging performance of an available charging station at the corresponding possible charging location;
determine a predicted state of charge of the energy store on arrival at the corresponding possible charging location; and
based on the determined charging performance and based on the predicted state of charge, determine a charging time for a charging process to bring the energy store to a third state of charge.

8. The control unit as claimed in claim 7, wherein the third state of charge
corresponds to the second state of charge; or
corresponds to a charging location-dependent state of charge, wherein the processor executes processing to determine the charging location-dependent state of charge of a possible charging location depending on a route between the possible charging location and the destination position.

9. The control unit according to claim 8, wherein the processor executes processing to:
for each of the one or more possible charging locations, determine a driving time for a route via the corresponding possible charging location to a destination position; and
determine a preferred charging location based on the sum of corresponding determined charging times and determined driving times.

10. The control unit according to claim 7, wherein the processor executes processing to:
for each of the one or more possible charging locations, determine a driving time for a route via the corresponding possible charging location to a destination position; and
determine a preferred charging location based on the sum of corresponding determined charging times and determined driving times.

11. A method for determining possible charging locations for charging an electrical energy store of a vehicle with an electric drive, wherein the method comprises the acts of:
determining a first state of charge of the energy store at a starting position of the vehicle;
determining a first range of the vehicle starting from the starting position based on the first state of charge;
determining that the first range of the vehicle is insufficient to reach a destination position of the vehicle;
determining a charging region between the starting position and the destination position based on a second state of charge of the energy store and based on the first range, wherein the second state of charge corresponds to an assumed state of charge of the energy store after carrying out a charging process at a charging location on a route between the starting position and the destination position; and
determining one or more possible charging locations in the charging region based on digital map information.

12. The method as claimed in claim 11, further comprising the acts of:
determining a second range of the vehicle starting from the destination position based on the second state of charge; and
determining the charging region between the starting position and the destination position based on the first range and based on the second range.

13. The method as claimed in claim 12, further comprising the acts of:
causing an output unit of the vehicle to output information about the one or more possible charging locations to a user of the vehicle;
determining a selected charging location from the one or more possible charging locations based on an input detected by way of an input unit of the vehicle; and
determining a route to the destination position via the selected charging location based on the digital map information.

14. The method as claimed in claim 13, further comprising the acts of:
determining information about one or more charging stations that are available at the one or more charging locations; and
causing the output unit of the vehicle to output the information about the one or more charging stations.

15. The method as claimed in claim 14, wherein the information about a charging station comprises one or more of:
an available charging performance of the charging station;
an availability of DC charging;
an operating state the charging station;
an availability of a free charging place at the charging station at a predicted time in the future at the charging station;
a predicted charging time to bring the energy store to the second state of charge; and
services available at the charging station.

16. The method as claimed in claim 13, further comprising the acts of:
predicting an arrival time at the selected charging location; and
sending a reservation request with the predicted arrival time at a charging station to the selected charging location by way of a communications unit of the vehicle.

17. The method as claimed in claim 11, further comprising the acts of:
determining the charging performance of an available charging station at the corresponding possible charging location;
determining a predicted state of charge of the energy store on arrival at the corresponding possible charging location; and
based on the determined charging performance and based on the predicted state of charge, determining a charging time for a charging process to bring the energy store to a third state of charge.

18. The method as claimed in claim 17, further comprising the acts of:
determining the charging performance of an available charging station at the corresponding possible charging location;
determining a predicted state of charge of the energy store on arrival at the corresponding possible charging location; and
based on the determined charging performance and based on the predicted state of charge, determining a charging time for a charging process to bring the energy store to a third state of charge.

19. The method as claimed in claim 11, further comprising the acts of:
for each of the one or more possible charging locations, determining a driving time for a route via the corresponding possible charging location to a destination position; and
determining a preferred charging location based on the sum of corresponding determined charging times and determined driving times.
